(19) United States
(12) Patent Application Publication
(10) Pub. No.: US 2010/0025474 A1
(43) Pub. Date: Feb. 4, 2010

(54) SYSTEM AND METHOD OF CARD ADORNMENT

(76) Inventor: David Behnen, JR., St. Louis, MO (US)

Correspondence Address: POLSINELLI SHUGHART PC, 700 W. 47TH STREET, SUITE 1000, KANSAS CITY, MO, 64112-1802, US

(21) Appl. No.: 12/511,364

(22) Filed: Jul. 29, 2009

Related U.S. Application Data
(60) Provisional application No. 61/084,487, filed on Jul. 29, 2008.

(51) Int. Cl. G06K 19/00; B32B 3/06; B23P 11/00

(52) U.S. Cl. 235/487; 428/99; 29/428

(57) ABSTRACT

A card adornment system, an adornment, and methods of adorning a card are described. The card adornment system includes a card member including a front face and a rear face. The card member defines at least one aperture passing from the front face of the card to the rear face of the card. At least one adornment is removably attached to the card member through the aperture. The adornment includes a deformable card penetration fitting attached or integral to a shaft. The shaft passes through the at least one aperture of the card member. A faceplate having a decorative front surface or decorative feature may be attached to the adornment. A sticker with a decorative surface may also be attached or affixed to the adornment.

### CROSS REFERENCE TO RELATED APPLICATION

This application claims the benefit of U.S. Provisional Patent Application No. 61/084,487 filed Jul. 29, 2008 and is herein incorporated by reference in its entirety

### FIELD OF THE INVENTION

The present invention generally relates to a system and method of adorning a card. In particular, the present invention relates to an adornment for a card that may be removably attached to a card by insertion through an aperture in the card.

### BACKGROUND OF THE INVENTION

Various types of cards, including credit cards, debit cards, Smart cards, gift cards, and many other cards are ubiquitous in modern commerce, financial transactions, and retail purchases. Stores, restaurants, credit card companies, banks and other businesses, under competitive pressure, have incorporated innovative features into their cards in order to gain a larger market share. Innovations in cards used in commerce have proceeded along two general directions. Credit card companies and banks have incorporated innovative features such as magnetic stripes, RFID chips, and inlaid photographs of cardholders into their cards in order to enhance the security of the commercial transactions that utilize the cards. Other businesses, such as department stores and restaurants, have incorporated various decorative features into their cards in order to make their cards more novel or aesthetically pleasing. To date, the decorative innovations of the cards have been limited mainly to the shape of the cards, and to the incorporation of different printed designs on the cards. One area of card ornamentation that has remained relatively unexploited is the addition of adornments that may be removeably attached to the cards.

A need exists in the art for a system of adorning a card with removeably attachable adornments. A need exists for a suitably designed adornment capable of being repeatedly attached and removed from a card.

### BRIEF DESCRIPTION OF DRAWINGS

FIG. 1 is a front perspective view of an embodiment of the card adornment system.

FIG. 2 is an exploded front perspective view of an embodiment of the card adornment system.

FIG. 3 is a front view of an embodiment of the card member.

FIG. 4 is a side sectional view of an embodiment of the card member.

FIG. 5 is a rear view of an embodiment of the card member.

FIG. 6 is a bottom sectional view of an embodiment of the card member.

FIG. 7 is a rear view of an embodiment of the card member.

FIG. 8 is a front view of an embodiment of the card adornment system.

FIG. 9 is a bottom sectional view of an embodiment of the card adornment system.

FIG. 10 is a close-up bottom sectional view of an embodiment of the card adornment system.

FIG. 11 is a front perspective view of an embodiment of the card adornment system.

FIG. 12 is a front perspective view of an embodiment of the card adornment system.

FIG. 13 is a close-up bottom sectional view of an embodiment of the card adornment system with the sticker attached to the adornment.

### DETAILED DESCRIPTION OF THE INVENTION

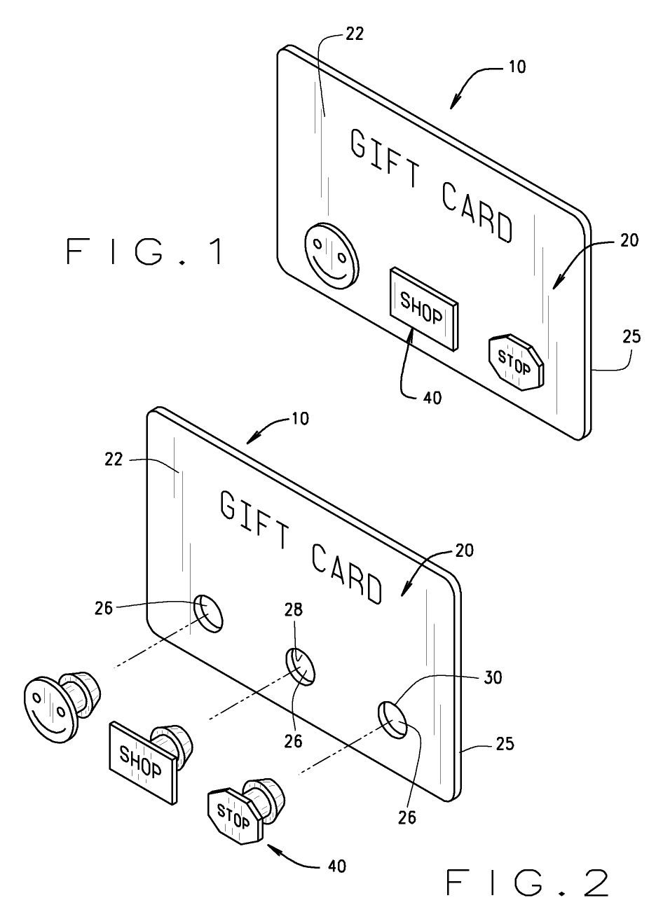

The present invention generally provides a card adornment system 10 that includes a card member 20 and at least one adornment 40, as illustrated in FIG. 1. The card member 20 includes at least one aperture 26. The at least one adornment 40 may be removably attached to the card member 20 by inserting the at least one adornment 40 through the at least one aperture 26. The at least one adornment 40 may be pulled from the aperture 26 and separated from the card member 26 and repeatedly attached to the same card member 20 or a different card member 20. The at least one aperture 26 is defined by the material that forms the card member 20, as illustrated in FIG. 2. The elements of the card adornment system 10 are described in detail below.

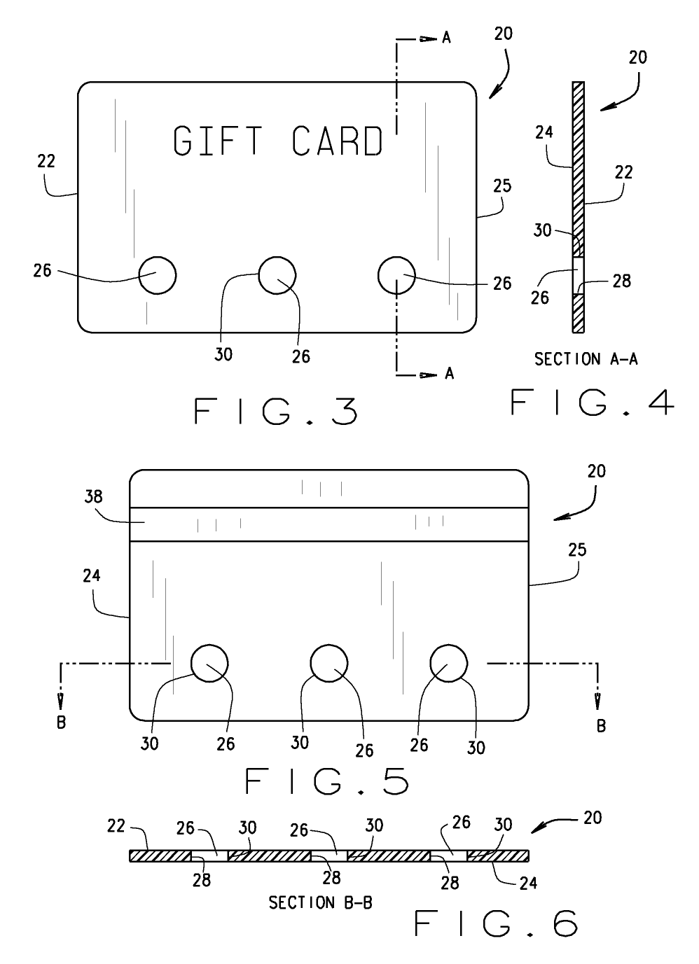

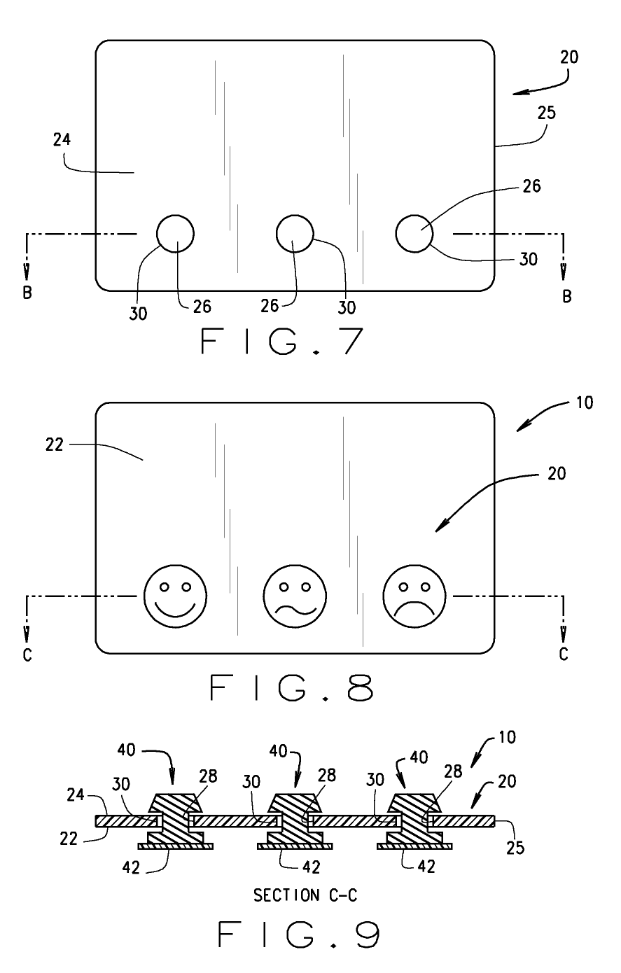

The card member 20, shown in FIG. 3 through FIG. 7, includes a front face 22 and a rear face 24. The card member 20 further includes an outer edge 25.

The material of the card member 20 defines at least one aperture 26, delineated by a perimeter 30 of the aperture 26, which is further defined by a side wall 28 of the aperture 26. The aperture 26 runs from the front face 22 to the rear face 24, and provides a space or void in the card member 20 through which to insert and remove the adornment 40. The apertures 26 may be located near the outer edge 25 of the front face 22 of the card member 20, or the apertures 26 may be located anywhere on the front face 22 of the card member 20, so long as sufficient material remains to define the side wall 28 of the aperture 26. One aperture 26 or a plurality of apertures 26 may be located in the card member 26.

The card member 20 comprises a material with a thickness ranging between about 0.01 inches and about 0.4 inches. The front face 22 may have a rectangular shape, a circular shape, a square shape, a triangular shape, or any other arbitrary shape so long as sufficient material exists to define the side walls 28 of the at least one aperture 26. The minimum dimension of the front face 22 may be at least about 1 inch, so long as sufficient material exists to define the side wall 28 of the at least one aperture 26.

The card member 20 comprises a resilient or non-deformable material that may include plastic, wood, metal, ceramic, cardboard, fiberglass, graphite-epoxy composites and combinations thereof. Any resilient or non-deformable material may be used, so long as the material may be formed to a sufficient thickness and may further be provided with the at least one aperture 26 with sufficient strength to withstand the repeated insertion and removal of the at least one adornment 40. The terms non-deformable and resilient materials include materials that will bend or give under normal circumstances, such as the plastics forming a typical credit card, but will also break or crease under extreme conditions, such as when the typical credit card is completely bent together on itself.

The shape of the perimeter 30 of the aperture 26 is sized and dimensioned to removably receive the adornment 40. The shape of the perimeter 30 of the aperture 26 may be circular, elliptical, square, triangular, hexagonal, octagonal, or any other shape suitable for removably receiving the adornment 40.

The dimension of the aperture 26 may be suitably sized to removably receive the adornment 40. The maximum dimension for the at least one aperture 26 may range between about 0.125 inches and about 0.5 inches. Individual apertures 26 on a card member 20 may have the same maximum dimension, or individual apertures 26 on a card member may have different maximum dimensions falling within the range described above. Adjacent apertures 26 on a card member 20 may be separated by a distance measured from the nearest adjacent side walls of the apertures 28 of at least 0.25 inches, to assure that sufficient material remains in the card member 20 to define the apertures 26.

The card member 20 may be a gift card, a stored value card, a credit card, a debit card, an identification card, a smart card, a business card, a consumer incentive card or any card for identification purposes. In an embodiment, the rear face 24 of the card member 20 may include a magnetic stripe 38, as shown in FIG. 5. In an embodiment, card member 20 may further comprise a RFID chip 39, as shown in FIG. 12.

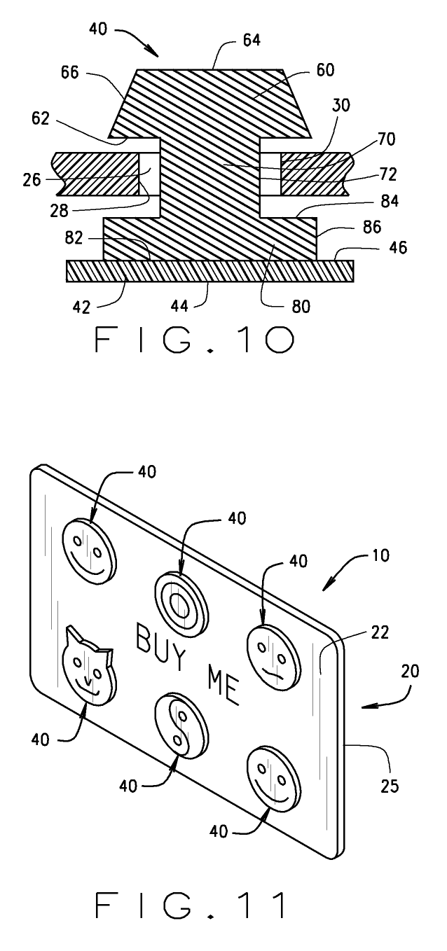

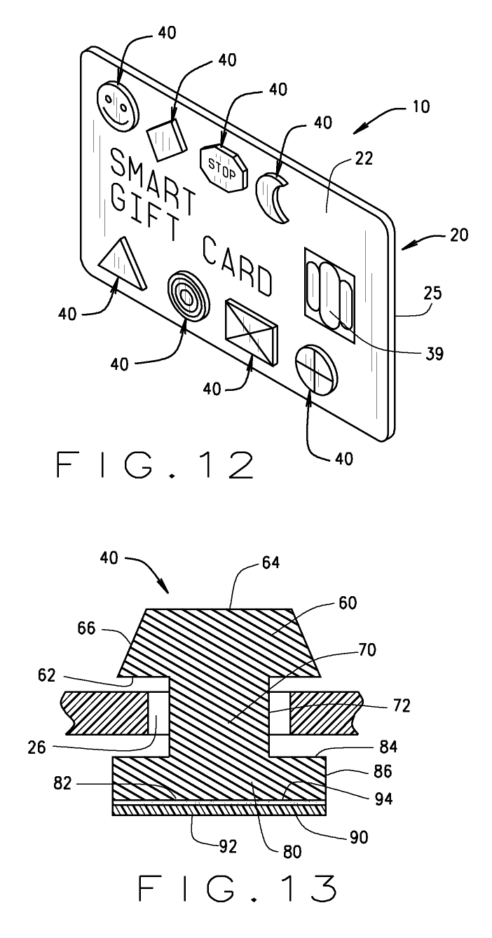

The adornment 40, may be removably attached to the card member 20 through the at least one aperture 26, as shown in FIG. 9 and FIG. 10. Referring to FIG. 10, the adornment 40 includes a shaft 70 with two opposing ends. A deformable card penetration fitting 60 is attached or integral to one end of the shaft 70 at a front surface 62 of the card penetration fitting 60. A faceplate attachment fitting 80 is attached to the opposite end of the shaft 70 at a rear surface 84 of the faceplate attachment fitting 80.

The adornment 40 may also include a decorative faceplate 42 attached to a front surface 82 of the faceplate attachment fitting 80 at a reverse face 46 of the faceplate 42. The decorative faceplate 42 may include surface ornamentation or a decorative feature.

The shaft 70, when the adornment 40 is removably attached to the card member 20, extends completely through the aperture 26. The shaft 70 defines a lateral surface 72. The shaft 70 may have a cross-sectional shape that is circular, elliptical, square, triangular, hexagonal, octagonal, or any other shape suitable for insertion through the aperture 26. The maximum cross-sectional dimension may range between about 0.125 inches and about 0.5 inches, so long as the maximum cross-sectional dimension is sufficiently small in order to pass through the aperture 26. The length of the shaft 70 may range between about 0.2 inches and about 1 inch and may be any length so long as there is sufficient length to extend completely through the thickness of the card member 20.

The shaft 70 is sized and dimensioned to provide a suitably rigid structure to push and pull the deformable card penetration fitting 60 through the aperture 26 when removeably attaching or detaching the adornment 40 from the card member 20. The shaft 70 may be constructed from any suitable non-deformable material including plastic, wood, metal, ceramic, cardboard, fiberglass, graphite-epoxy composites. Any deformable material such as rubber, silicon, elastic, or flexible plastic may be used if the shaft 70 is sufficiently short in length and wide in cross-sectional dimension to still provide sufficient structural stiffness to push and pull the card penetration fitting 60 through the aperture 26.

The card penetration fitting 60 is the portion of the adornment 40, that is inserted into and through the aperture 26 of the card member 20. The card penetration fitting 60 includes the front surface 62 that is attached to one end of the shaft 70, a rear surface 64, and a lateral edge 66. Generally, the rear surface 64 has a smaller surface area than the front surface 62 to facilitate pushing the card penetration fitting 60 through the aperture 26. The card penetration fitting 60 is made of a deformable material that may include silicon, rubber, elastic, flexible plastic, and combinations thereof. The card penetration fitting 60 may have a cross sectional shape that is circular, elliptical, square, triangular, hexagonal, octagonal, or any other shape suitable for insertion through the aperture 26. The maximum cross-sectional dimension of the card penetration fitting 60 may range between about 0.125 inches and about 0.75 inches, so long as the maximum dimension is slightly larger than the maximum cross-sectional dimension of the aperture 26.

The card penetration fitting 60 is made of a deformable material that deforms as it is inserted into the aperture 26 of the card member 20. The card member 20 is made of a resilient or non-deformable material that generally maintains its shape despite the stress or force of the insertion of the card penetration fitting 60 into the aperture 26. The card 20 and the material of the card 20 forming the aperture 26 are generally more rigid and non-deforming as compared to the card penetration fitting 60, the shaft 70, and the faceplate attachment fitting 80.

When inserted into the aperture 26, the card penetration fitting 60 elastically deforms when pressed into the aperture 26, allowing the card penetration fitting 60 to pass from the front face 22 to the rear face 24 of the card member 20. Once the card penetration fitting 60 has passed through the aperture 26, the card penetration fitting 60 elastically rebounds to its larger original shape and dimension, thereby attaching the adornment 40 to the card member 20. As such, the card penetration fitting 60 includes the relaxed state that resists passing through the aperture 26 and a deformed state that passes through the aperture 26. The adornment 40 may be pulled out of the aperture 26 in a similar manner. The card penetration fitting 60, in its relaxed or original state, is larger in its dimension as compared to the aperture 26. Typically, the diameter or width of the card penetration fitting 60 is larger than the diameter or width of the aperture 26.

The lateral edge 66 of the card penetration fitting 60 may be flat or chamfered. The lateral edge 66 may have a narrower rear surface 64 relative to the front surface 62. When the narrower rear surface 64 is inserted into the aperture 26, the chamfer of the lateral edge 66 aids in guiding the card penetration fitting 60 into the aperture 26. In an embodiment, the lateral edge 66 may have a narrower front surface 62 relative to the rear surface 64, or the front surface 62 and rear surface 64 may be comparably sized.

The faceplate attachment fitting 80 is attached to the end of the shaft 70 opposite to the card penetration fitting 60. The faceplate attachment fitting 80 includes a front surface 82, a rear surface 84, and a lateral edge 86. The cross-sectional shape of the faceplate attachment fitting 80 may be circular, elliptical, square, triangular, hexagonal, octagonal, or any other shape. Because the faceplate attachment fitting 80 does not pass through the aperture 26, the cross sectional shape of the faceplate attachment fitting 80 is not subject to the same size or shape constraints placed on the card penetration fitting 60. The faceplate attachment fitting 80 may be made of any suitable deformable or nondeformable material including plastic, wood, metal, ceramic, cardboard, fiberglass, graphite-epoxy, silicon, rubber, elastic, flexible plastic, or combinations thereof. In an embodiment, the front surface 82 of the faceplate attachment fitting 80 may be decorated.

The faceplate attachment fitting 80 generally has a larger size in diameter or width as compared to the card penetration fitting 60. The faceplate attachment fitting 80 receives decoration or decorative features on its front surface 82 as described herein. The front surface 82 may include a flat or planar surface to receive a sticker or decorative faceplate. The flat or planar surface provides a contact region for adhesives to receive the sticker or the decorative faceplate.

A faceplate 42 may be attached to the front surface 82 of the faceplate attachment fitting 80 at the reverse face 46 of the faceplate 42. The faceplate 42 may be constructed of any suitable deformable or non-deformable material including plastic, wood, metal, ceramic, cardboard, fiberglass, graphite-epoxy, silicon, rubber, elastic, flexible plastic, or combinations thereof. In an embodiment, the thickness of the faceplate 42 may be comparable to the thickness of the card member 20, and the minimum dimension of the faceplate 42 may be dimensioned to be at least slightly larger than the minimum cross-sectional dimension of the faceplate attachment fitting 80, so as to completely cover the faceplate attachment fitting 80 when viewed from the front. The exposed face of the faceplate 42 may be decorative so as to present a design when the adornment 40 is removably attached to the card member 20. The design of the exposed face of the faceplate 42 may include any design or indicia, such as, for example, trademarks, pictures, artwork, rhinestones, jewels, words, phrases, coupons, etc.

In certain embodiments, as shown in FIG. 13, the faceplate 42 may be replaced with a sticker 90 that adhesively connects to the front surface 82 of the faceplate attachment fitting 80. The sticker 90 includes a front surface 92 that is printed with an indicia, such as, for example, trademarks, pictures, designs, logos, artwork, words, phrases, coupons, etc. A rear surface 94 of the sticker 90 includes a permanent, semi-permanent, or temporary adhesive. The adhesive may include pressure-sensitive adhesives or peelable adhesives that provides for the user to adorn the adornment 40 with any sticker 90 of their choosing. The adhesives may include acrylic and other conventional adhesives for such stickers. The sticker 90 may be made from a variety of materials, including vinyl, plastic, foils, litho, latex, paper materials, etc.

The adornment 40 may include the card penetration fitting 60, the shaft 70, and the faceplate attachment fitting 80 formed as a unitary or integral structure, i.e., these components are formed as a single piece. The faceplate 42 may then be attached with, for example, an adhesive, to the faceplate attachment fitting 80. The sticker 90 may also be attached via the adhesive of the sticker 90 to an integral unit of the card penetration fitting 60, the shaft 70, and the faceplate attachment fitting 80.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A card adornment system, comprising:
a. a card member comprising a front face and a rear face and defining at least one aperture passing from the front face of the card member to the rear face of the card member; and,
b. at least one adornment removably attached to the card member through the aperture, the adornment comprising a deformable card penetration fitting attached or integral to a shaft, wherein the shaft passes through the at least one aperture of the card member.

2. The card adornment system of claim 1, wherein the card member comprises a non-deformable or resilient material.

3. The card adornment system of claim 1, wherein the card member comprises a non-deformable or resilient material that defines the aperture.

4. The card adornment system of claim 1, wherein the card penetration fitting is formed of a deformable material.

5. The card adornment system of claim 1, wherein the shaft comprises opposing ends, and the deformable card penetration fitting is attached or integral to one opposing end of the shaft and a faceplate attachment fitting is attached or integral to the other opposing end of the shaft.

6. The card adornment system of claim 5, wherein the adornment further comprises a faceplate attached to the faceplate attachment fitting.

7. The card adornment system of claim 6, wherein the faceplate comprises a decorative surface or feature.

8. The card adornment system of claim 1, wherein the card member is selected from the group comprising gift card, stored value card, credit card, identification card, smart card, and consumer incentive card.

9. The card adornment system of claim 1, wherein the card member further comprises a magnetic strip or an RFID chip.

10. The card adornment system of claim 1, wherein the card penetration fitting further comprises a lateral edge that is chamfered with a narrower end situated at a distal face of the card penetration fitting.

11. The card adornment system of claim 1, wherein a sticker is applied to the at least one adornment.

12. An adornment for a card, comprising:
a. a shaft comprising two opposing ends;
b. a deformable card penetration fitting attached to one end of the shaft, the deformable card penetration fitting comprising an elastic material; and,
c. a faceplate attachment fitting attached or integral to the opposing end of the shaft.

13. The adornment of claim 12, further comprising a sticker or a faceplate attached to the faceplate attachment fitting.

14. An adornment for a card, comprising:
a. a shaft comprising two opposed ends;
b. a deformable card penetration fitting comprising a front face, a rear face, and a lateral edge, wherein the front face of the card penetration fitting is attached or integral to one end of the shaft;
c. a faceplate attachment fitting comprising a front face, a rear face, and a lateral edge, wherein the rear face of the faceplate attachment fitting is attached or integral to an opposing end of the shaft;
d. a faceplate comprising a decorative front surface and a rear surface, wherein the rear surface of the faceplate is attached or integral to the front face of the faceplate attachment fitting.

15. The adornment of claim 14, wherein the card penetration fitting comprises a deformable material.

16. The adornment of claim 14, wherein the card penetration fitting is sized and dimensioned to elastically deform in order to pass through an aperture having a smaller size than a size of the card penetration fitting.

17. The adornment of claim 14, wherein the lateral edge of the card penetration fitting is chamfered, and wherein the rear face of the card penetration fitting is narrower than the front face of the card penetration fitting.

18. The adornment of claim 14, wherein the shaft, the deformable card penetration fitting, and the faceplate attachment fitting form a unitary or integral structure.

19. A method of adorning a card, comprising:
a. providing a card member defining at least one aperture;
b. providing at least one adornment comprising a faceplate attachment fitting and a deformable card penetration fitting attached to opposing ends of a shaft; and,
c. inserting the deformable card penetration fitting of the at least one adornment through the at least one aperture of the card member.

20. The method of claim 19, wherein the method further comprises deforming the deformable card penetration fitting as the deformable card penetration fitting is inserted through the at least one aperture.

21. The method of claim 19, wherein the method further comprises applying a sticker or a faceplate to the faceplate attachment fitting.
